(19) United States
(12) Patent Application Publication
(10) Pub. No.: US 2005/0036573 A1
(43) Pub. Date: Feb. 17, 2005

(54) Baseband receiver for binary symbol data

(76) Inventors: Liang Zhang, Beijing (CN); Liang Li, Mission Viejo, CA (US); Zhen Zhen Chen, Beijing (CN); Chenyang Yang, Beijing (CN)

Correspondence Address: William J. Kolegraff, 3119 Turnberry Way, Jamul, CA, 91935, US

(21) Appl. No.: 10/641,438

(22) Filed: Aug. 15, 2003

(51) Int. Cl. H04K 1/00

(52) U.S. Cl. 375/343

(57) ABSTRACT

A baseband process is provided for operating on a receiver in a communication system, such as an 802.15.4 communication system in the 868/915 MHz band In one aspect, the baseband process is useful for decoding a baseband signal, and in another aspect is useful for determining a clear channel assessment. In decoding the baseband signal, the process digitizes the baseband signal into sample sets according to a symbol period. The sample sets may be, for example, from sequential symbols having a known symbol value, such as from the preamble portion of a data frame. Since the symbol values are already known, the process may determine a reference value by correlating two or more known sample sets. To decode a sample set having an unknown code symbol, the process determines a correlation value by correlating that unknown sample set to a sample set having a known code symbol, which is typically the adjacent and preceding sample set. If the correlation value is the same as the reference value, then the unknown sample has the same code symbol as the known code symbol. The process advances to the next symbol period and sample set to sequentially decode symbols in the data frame.

### BACKGROUND

This application claims benefit of priority to U.S. patent application No. 60/391,888 filed Jun. 27, 2002 and entitled “Demodulation Algorithm for the 802.15.4 Receiver”, to U.S. provisional application No. ______ filed Sep. 13, 2002, entitled “A Kind of Low Complexity Receiver Structure for the Wireless Transceiver Based on IEEE 802.15.4 Standard at 2.4 GHz”, to U.S. provisional application No. ______ filed ______, entitled “Sequence De-Modulation Algorithm for 802.15.4 Receiver at 868/915 MHz”, to U.S. patent application Ser. No. 10/422,321 filed Apr. 24, 2003 and entitled “Method for Synchronizing or Decoding a Baseband Signal”, and to U.S. patent application Ser. No. 10/455,207 filed Jun. 5, 2003, and entitled “A Baseband Receiver and Method of Using Same”, all of which are incorporated herein by reference.

The field of the present invention is receivers for communications systems. In a particular example, the invention relates to a baseband receiver process operating on a receiver for receiving a communication signal compliant with the 802.15.4 standard in the 868/915 MHz band.

Receivers form an important part of any communications system. Receivers cooperate with a transmitting device to receive an information signal and decode the information from that signal. In practice, the receiver portion is often coupled with the transmitter portion to create a transceiver. Often, this transceiver is portable so that a wireless communication may be received irrespective of location. In its portable form, it is particularly desirable to have the receiver operate with low power and be implemented in a cost efficient manner. In this way, the portable device has an affordable initial cost, and may operated for extended periods of time using a portable energy source such as a battery. However, although low cost and low power usage are desirable characteristics, the primary demand on a portable receiver is to accurately and efficiently decode a received signal, and to remain compliant with the appropriate communication standard.

Most modern communication systems comply or are based upon one or many communications standards. These communications standards are promulgated by industry associations and groups to facilitate interoperability between devices. For example, the IEEE is an organization responsible for promulgating several communication standards. Each communication standard has particular strengths and goals, and also certain associated implementation costs. For example, communication standards operating at very high data rates tend to operate over the greatest distances, allow for the greatest number of users, and are the most expensive to implement. Other communication standards set a relatively low data rate, a relatively low number of users, and may be relatively inexpensive to implement. One standard, the 802.15.4 standard is intended to be a relatively low cost and low power wireless communication standard. With the relatively low data rate, 802.15.4 compliant devices are expected to be targeted to such markets as industrial sensors, commercial metering, consumer electronics, toys and games, and home automation. Each of these markets has a great cost sensitivity, and will expect that any portable device to efficiently use its battery or other portable energy source.

The 802.15.4 specification operates in either the 2.4 GHz band or in the 868/915 MHz band, and uses a wireless transmission technology to dynamically configure and initialize a personal area network. The standard particularly sets out implementations and structures for the transmitter portion of the communication systems, but is far less detailed in describing receiver implementations.

Implementing a receiver for the 802.15.4 has been made particularly difficult due to the overall architecture of the 802.15.4 network. According to the standard, the transmitter does not provide a separate synchronization process to allow a receiver to synchronize to the transmission. Instead, 802.15.4 relies upon self-synchronization by the receiver. Self-synchronization can be a time consuming and processor intensive process, thereby using scarce power resources available at the portable receiver. Further, the standard allows the frequency of a transmission to vary as much as 40 parts per million (ppm) when operating in the 868/915 MHz band. Also, the magnitude of the frequency offset between devices may vary depending upon time, temperature, and will fluctuate substantially depending on which specific device is transmitting. Thus the standard permits the transmitter to introduce a substantial 40 ppm frequency offset at each receiver, which is substantial, variable and unpredictable.

The 802.15.4 standard is also a channel-based communication system, with the usual adjacent channel interference, fading, and noise associated with such architecture. The signal coming from an 802.15.4 transmitter, therefore suffers from degradation from a substantial frequency offset, adjacent channel interference, fading, noise, and possibly other degrading factors. In this way, the receiver needs to be constructed to properly self-synchronize and decode the incoming 802.15.4 signal, even when the signal is highly degraded.

As with many communication systems, the 802.15.4 communication system is a frame based system. As such, the transmitter assembles a data frame, encodes the data frame, modulates the data frame onto a carrier frequency, and transmits the modulated information signal to the receiver. The receiver is expected to detect the modulated signal, remove the carrier to generate a baseband signal, and synchronize with and decode the baseband signal. In the 802.15.4 standard, the frame has an 8-symbol preamble, which indicates the presence of a data frame. Accordingly, the 802.15.4 compliant receiver must synchronized to the baseband signal within only 8 symbols. The process of synchronizing to a degraded asynchronous baseband signal with only 8 symbols is typically accomplished by either providing for substantial parallel processing capability in the form of a complex gate configuration, or providing a relatively high speed processor for quickly performing algorithmic calculations. Either solution tends to use substantial power and be implemented with high-end and relatively high cost parts. In this way, even though the 802.15.4 standard is intended to be a low power and low cost arrangement, the architectural constraints of the standard may hinder building such a low cost and low power receiver. Therefore it would be desirable to have a receiver process operating on a receiver that could reliably recover information from a highly degraded baseband signal, but yet realizable in a relatively low cost and relatively low power construction.

### SUMMARY

Briefly, the present invention provides a baseband process operating on a receiver in a communication system, such as an 802.15.4 communication system in the 868/915 MHz band. In one aspect, the baseband process is useful for decoding a baseband signal, and in another aspect is useful for determining a clear channel assessment. In decoding the baseband signal, the process digitizes the baseband signal into sample sets according to a symbol period. The sample sets may be, for example, from sequential symbols having a known symbol value, such as from the preamble portion of a data frame. Since the symbol values are already known, the process may determine a reference value by correlating two or more known sample sets. To decode a sample set having an unknown code symbol, the process determines a correlation value by correlating that unknown sample set to a sample set having a known code symbol, which is typically the adjacent and preceding sample set. If the correlation value is the same as the reference value, then the unknown sample has the same code symbol as the known code symbol. The process advances to the next symbol period and sample set to sequentially decode symbols in the data frame.

The disclosed baseband process includes a decoding process optimized for a baseband signal carrying binary symbol information. In one example, the process determines a reference sign by correlating sample sets from known symbols in the preamble. The process generates a next sample set, where the next sample set has an unknown code symbol, and correlates that next sample set with a sample set having a known code symbol. The correlation result is expressed as a correlation sign, and the correlation sign is compared to the reference sign. If the correlation sign and the reference sign are the same, then the next sample set is decoded as the same code symbol as the known code symbol. In a similar manner, if the correlation sign and the reference sign are different, then the next sample set is decoded as a different code symbol as the known code symbol.

In another aspect of the baseband process, the baseband process may be useful for determining a clear channel assessment (CCA). The CCA process is used to determine if a particular channel is available for use by the communication system, and in particular, may be used to determine if the channel is in use by another communication system using the same communication standard. In operation, the CCA process digitizes the channel and generates sample sets according to a defined symbol period. The process performs multiple correlations between sample sets, with each sample set offset by a predetermined amount from the previous sample set. For example, both sample sets may be advanced by a single data point for each correlation. The correlation results are accumulated, and the results compared to a threshold. If the threshold criteria are not met, then the CCA process reports that the channel is clear and available for use by the communication system.

Advantageously, the disclosed baseband process provides a highly efficient decoding process that sequentially decodes symbols using minimal processing resources. In a similar manner, the baseband process enables an efficient CCA process to be implemented, without the need for synchronizing or decoding the channel under investigation. Accordingly, the decode and CCA processes may be implemented in a compact, low cost, and low power construction. These and other advantages will become apparent by review of the figures and detail descriptions that follow.

### BRIEF DESCRIPTION OF THE DRAWINGS

FIG. 1 is a block diagram of a baseband receiver in accordance with the present invention;

FIG. 2 is a flowchart of a baseband receiver process in accordance with the present invention;

FIG. 3 is a block diagram of a device architecture for a baseband receiver;

FIG. 4 is a block diagram of an automatic gain controller in accordance with the present invention;

FIG. 5 is a block diagram of a baseband process in accordance with the present invention;

FIG. 6 is a block diagram of a frame detector in accordance with the present invention;

FIG. 7 is a block diagram of a frame detector in accordance with the present invention;

FIG. 8 is a block diagram of a receiver in accordance with the present invention;

FIG. 9 is a symbol table useful in one example of a receiver in accordance with the present invention;

FIG. 10a is a block diagram of a baseband process in accordance with the present invention;

FIG. 10b is a block diagram of another baseband process in accordance with the present invention;

FIG. 11 is a block diagram of a process to predetermine signals for a reference table in accordance with the present invention;

FIG. 12 is a block diagram of a baseband process in accordance with the present invention

FIG. 13 is a flowchart of a decode process in accordance with the present invention;

FIG. 14 is a diagram of a decode process in accordance with the present invention;

FIG. 15 is a flow chart of a method for reporting clear channel assessment in accordance with the present invention; and

FIG. 16 is an illustration of a method for reporting clear channel assessment in accordance with the present invention

### DETAILED DESCRIPTION

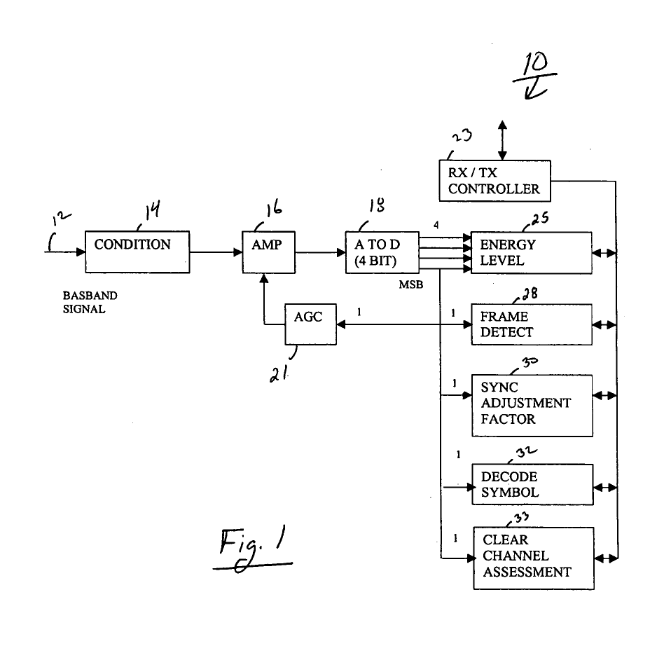

Referring now to FIG. 1, a baseband process 10 is illustrated. The baseband process 10 operates on a baseband portion of a communication receiver system. For example, the receiver may be part of a transceiver configured to communicate on a wireless network such as an 802.15.4 compliant network in the 868/915 MHz band. Although the process 10 will be described operating in the 802.15.4 standard at the 868/915 MHz band, it will be appreciated that the baseband process may be configured to function with other communication systems, bands, and standards. In general, baseband process 10 is useful for identifying particular characteristics in the baseband signal. For example, such characteristics may be the identification for of a synchronization adjustment or the decoding of a data symbol. It will be appreciated that the baseband process 10 maybe useful for identifying other characteristics of a baseband signal, such as a clear channel assessment indication.

Baseband process 10 provides a particularly efficient method for decoding symbol data from the baseband signal. The efficiency of the baseband process 10 enables a highly efficient and low power receiver configuration. Accordingly, baseband process 10 is useful as the receiver portion of an 802.15.4 transceiver, where low power usage and low implementation costs are important considerations. Baseband process 10 also provides a particularly efficient method and structure for clear channel assessment in the 868/915 MHz band for the 802.15.4 standard.

In a typical arrangement, baseband process 10 operates responsive to an instruction from another portion of the wireless receiver system, for example, an RX/TX (receiver/transmit) module 23. The baseband process 10, without any need to synchronize to the communication system, may detect 28 that a data frame is being received. After a data frame is confirmed, the baseband process 10 synchronizes to the baseband signal by determining a sync adjustment factor 30. Once the adjustment factor is determined, the baseband process operates in sync with the received baseband signal, and compensates for frequency offset effects. The baseband process thereafter proceeds to sequentially decode symbols in the baseband signal. Generally, the decoding process compares a known current symbol to an unknown next symbol to efficiently decode the next symbol. Importantly the decoding process compensates for certain system disturbances and distortions, thereby increasing decoding accuracy and receiver efficiency. The decode process then advances to decode the following unknown symbol. Since the decode process repetitively correlates only two adjacent symbols, the decode circuitry is relatively simple, fast, compact, and power efficient.

Baseband process 10 is shown operating on the 868/915 MHz bands of the 802.15.4 standard. The 868/915 MHz standard specifies a 868 MHz band that operates at a data rate of 20 Kbit/ second, and a 915 MHz band that operates at a data rate of 40 Kbit/second. Both bands employ a direct sequence spread spectrum, and use a binary phase shift key (BPSK) modulation platform. Since the 868/915 MHz bands use a BPSK process, data symbols are represented as binary data. Stated alternatively, the 868/915 bands use only two symbols, which are represented by a “1” or a “0”. Each symbol (bit) is mapped to a 15-bit chip prior to modulation. Accordingly, the 868 MHz band has a chip rate of 300K chips/second, while the 915 MHz band has a chip rate of 600K chips/ second.

Baseband process 10 receives a baseband signal 12 from another portion of the receiver. The baseband signal 12 has been demodulated to remove the carrier frequency; however, the effects due to a frequency offset, noise, interference, fading, and time shift are still present in the baseband signal 12. Since the carrier signal has been removed from the baseband signal 12, baseband signal 12 generally represents a waveform that is carrying pulse information. The shape of the pulses generally relate to a binary encoding, however, the pulse shape may be substantially deformed due to the frequency offset, noise, and other degrading influences.

Baseband process 10 receives a baseband signal that may be conditioned 14, for example by filtering or other process. An amplifier 16 receives the conditioned signal. The amplifier 16 may be for example, an operational amplifier. The amplified signal is received in to an A to D (analog to digital) converter 18. The A to D converter operates responsive to a local clock source, so is not synchronized with the received baseband signal. The A to D converter 18 converts the analog amplified signal into a digital representation. For example, the A to D converter 18 may operate to generate a series of digital data sample points that represent the baseband signal. In one example, the A to D converter generates 60 data points for every symbol period of the baseband signal, thereby providing 4 samples for each chip value. It will be appreciated that other sampling speeds may be used dependant on application specific needs. To provide 4 samples for each chip value, the A to D converter may be operated at 2.4 MHz for the 915 MHz band, and at 1.2 MHz for the 868 MHz band. It will be appreciated that the sample rate may be adjusted according to application needs. For example, additional accuracy and detection speed might be obtained by increasing sample rate, and power might be conserved further by reducing the sample rate.

The A to D converter 18 is constructed as a multi-bit converter, and in one example is a four-bit converter. It will be appreciated that other bit lengths may be used consistent with this disclosure. The digitized data signal is received into energy level circuitry 25 where an energy level is calculated for the baseband signal. In some wireless communication standards, such as the 802.15.4 standard, the wireless receiver is required to report an energy level with a specific resolution. To facilitate accurate computation of the energy level, the full resolution of the digital data is used by the energy level circuitry. Accordingly, the number of bits received from the A to D converter 18 may be adjusted according to the resolution required for the energy level computation. Once the energy level is determined, the energy level is passed to the Rx/Tx controller 23 where the energy level is communicated with the base station or other parts of the communication system.

Due to the resolution requirements of the energy level circuitry 25, the A to D converter 18 is selected to output a four-bit resolution. However, it has been found that other functions for the baseband receiver may be accomplished using less than the full resolution of the digital data. Indeed, some functions operate advantageously using only a single bit of resolution. In this regard, the most significant bit from the A to D converter 18 is used for frame detect 28, sync adjustment 30, decode symbol 32, clear channel assessment 33, and the automatic gain control 21. By using fewer bits of resolution in selected functions, the complexity of the receiver circuitry may be reduced, receiver efficiency improved, and power conserved.

Before proceeding to describe the specific decode and CCA functions, the general functions of the baseband process 10 will first be described. The automatic gain control (AGC) 21 generates a gain setting that is used to adjust the gain of amplifier 16. For example, if the amplifier 16 is generating a signal that is saturating the A to D converter 18, then the AGC function will reduce the gain of the amplifier, and if the amplifier is generating a signal that is not sufficiently driving the A to D converter 18, then the AGC function will increase the gain of the amplifier. Since significant function in the receiver circuitry are dependent on receiving accurate and stable digitized data, it is important that the AGC be able to quickly and efficiently set and adjust the amplifier. For example, the preamble for an 802.15.4 signal is only 8 symbols in duration. Within that 8 symbols, the AGC needs to stabilize, a frame needs to be detected, and a sync adjustment determined. In order to increase accuracy of the receiver, it is desirable that the AGC, frame detect, and sync process occur in less than 8 symbols, for example, in as few as 3 to 4 symbols. In this regard, the baseband process 10 has structures specifically arranged for efficient receiver operation.

The AGC 21 receives the most significant bit from the A to D converter 18. The automatic gain control circuitry 18 generally counts the number of times the most significant bit is set high in a given period of time, and if the number of counts exceeds a predefined threshold, then the gain setting for the amplifier 16 is reduced. In a similar matter, if the number of counts is fewer than a set predefined threshold, then the gain of amplifier 16 is increased. In this way the automatic gain circuitry 21 provides an efficient structure for controlling the gain of amplifier 16 using only a single bit of resolution. Although AGC 21 uses only the most significant bit, it will be appreciated that other bits may be used. For example, the 3 lower bits could be monitored, with the AGC set to count each occurrence of a 7 (a “111”). Other bit resolutions may be used consistent with this disclosure.

Baseband process 10 also may include frame detect circuitry 28. The frame detect circuitry is included to make the overall decoding process more efficient by allowing some circuit modules to be activated only after a data frame is found. However, It will be appreciated that the frame detect circuitry may be optional in some implementations. In baseband process 10, the frame detect circuitry 28 is used to determine if the baseband signal includes a likely frame of data. It is desirable to conserve power by deactivating selected functions in the receiver until a frame is detected. In this way, a minimal amount of circuitry may be operational to receive, amplify, and detect the frame of the baseband signal, while other circuitry may be activated only upon the detection of a likely frame. More specifically, frame detect 28 monitors for the presence of the preamble. While the frame detect 28 is monitoring for the preamble, the sync adjustment 30 and decode symbol 32 circuitry may be deactivated, thereby saving power. It will be appreciated that other aspects of the receiver and transceiver may be deactivated during the frame detect process. Once the frame detect circuitry 28 detects a frame, then the sync offset 30 and the decode symbol 32 circuitry may be activated for synchronizing the receiver to the baseband signal and decoding symbols. The circuitry for the clear channel assessment 33 may be activated responsive to requests by the RX/ TX controller 23, for example.

In the baseband process 10, the frame detect circuitry 28 is constructed to detect preamble symbols using only the most significant bit from the A to D converter 18. The use of only a single bit to perform frame detection enables a highly efficient and power-conserving frame detection process. Further, as described in detail earlier in this disclosure, the sync adjustment circuitry 30, the decode symbol circuitry 32, and the clear channel assessment circuitry 33 may be constructed to also operate on only a single bit from the A to D converter 18.

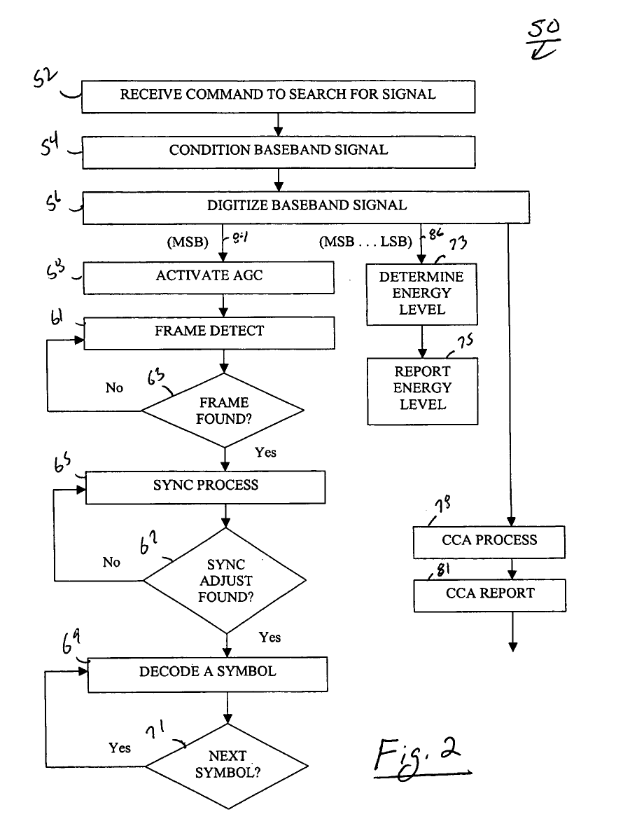

Referring now to FIG. 2, a baseband process 50 is illustrated. Baseband process 50 initiates with a search command being received from a Tx/Rx controller instructing the receiver to search for a communication signal as shown in block 52. The Tx/Rx controller may be, for example, the MAC access layer in a 802.15.4 transceiver. It will be appreciated that the command may be received from other sources, or that selected functions of the receiver may operate continually. To conserve power, much of the receiver circuitry may be inactivated until the search command is received. Once the search command is received, then selected receiver functions may be activated to search for a frame.

A signal is received, and that signal may include a baseband information signal. The received signal may be conditioned as shown in block 54. This conditioning may be, for example filtering, and may include other active or passive functions. Further, it will be appreciated that the conditioning process may be done at other parts of the baseband process, for example after the digitizing process of block 56. The conditioned baseband signal is digitized in block 56. In one example, the baseband signal is digitized into a four-bit data signal at a rate that provides 4 samples for each chip value. It will be appreciated that other bit lengths may be used depending on specific applications and communication standard requirements. The full resolution of bits 86 are passed to energy level circuitry where an energy level is determined as shown in block 73. The energy level is then reported as an energy level in block 75 to the receive and transmit controller (Rx/Tx). The receive and transmit controller may thereby report the energy level in the baseband signal to other aspects of the communication system.

Other portions of the receiver circuit may be constructed using less than the full resolution of the digital data. For example, only the most significant bit 84 is used in other selected aspects of the baseband process. In one aspect, the most significant bit 84 is used to activate and perform an automatic gain control 58. Generally, the automatic gain control works by counting the number of most significant bits that have been set in a given time period. If the number of counted “high” states exceeds a threshold, then the AGC circuitry assumes that the digitizer is becoming saturated and lowers the gain on an amplifier. In a similar manner, if the automatic gain control circuitry counts fewer than a threshold number of “high” states in a given time period, then the automatic gain circuitry assumes that the baseband signal is not amplified sufficiently and therefore increases the gain on an amplifier.

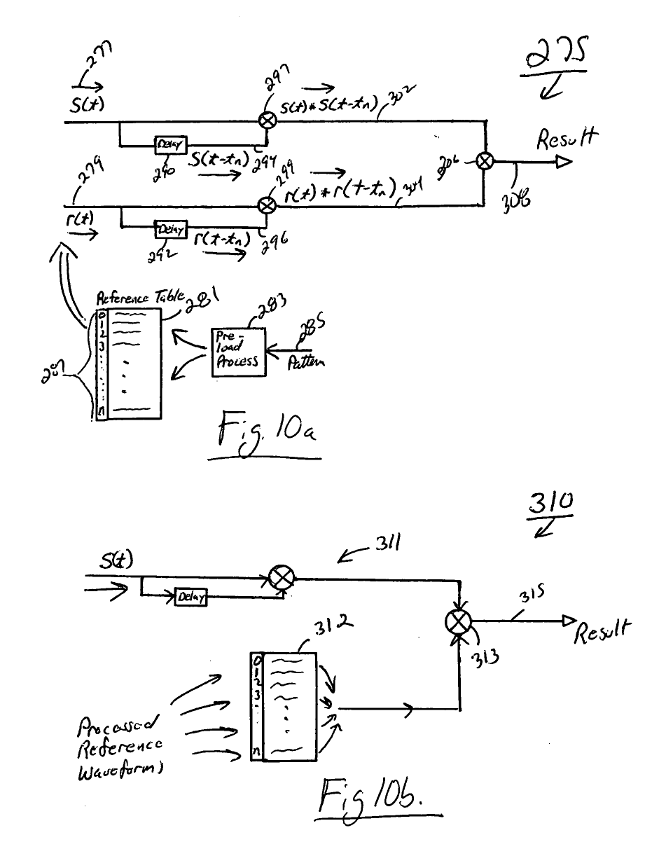

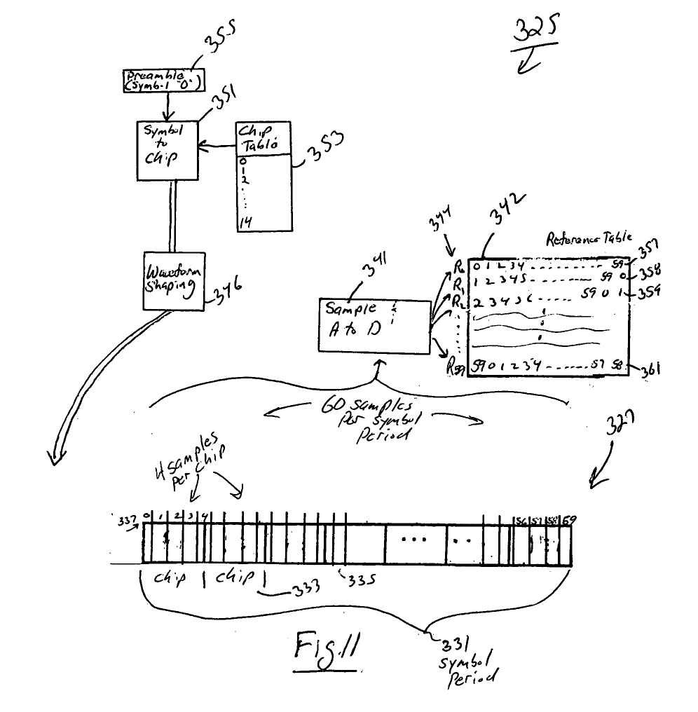

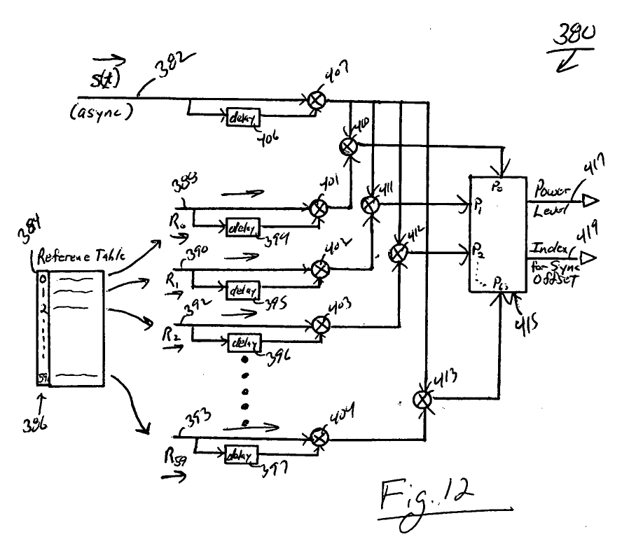

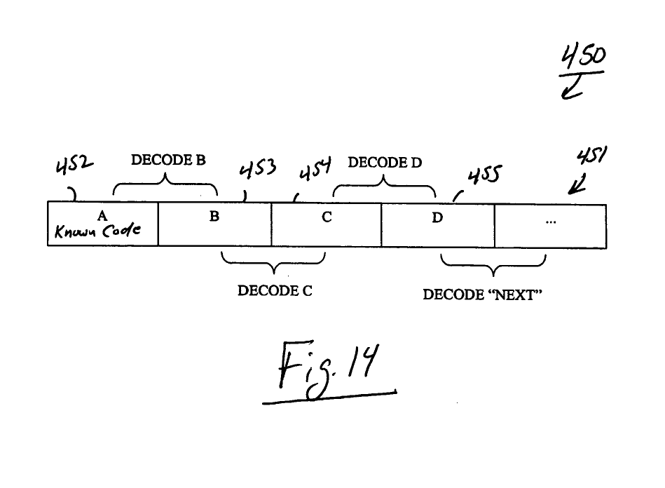

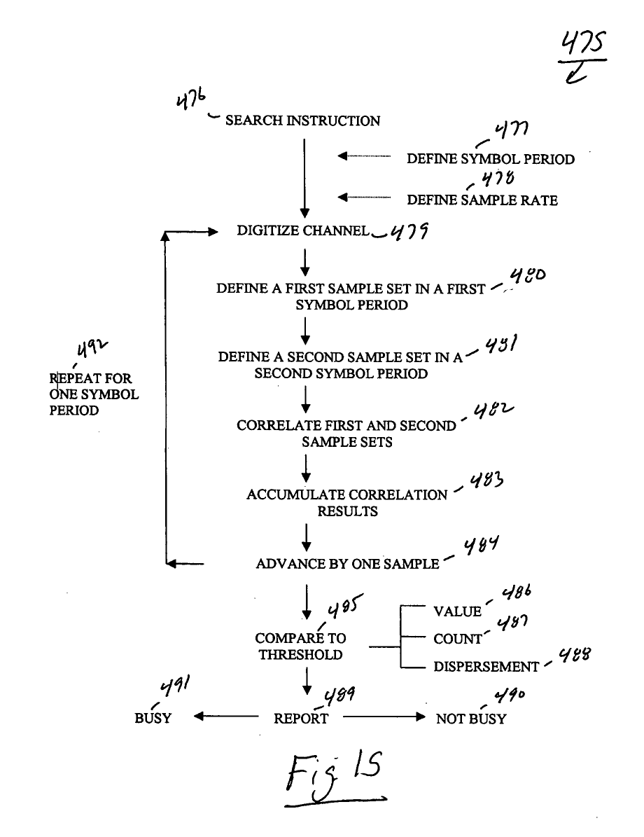

The most significant bit 84 is also used for frame detect as shown in block 61. The frame detect circuitry seeks to find known preamble symbols, and when the preamble symbols are found, the frame detect circuitry indicates that a data frame is likely to follow. If a frame is found as indicated in block 63, then a synchronization adjustment process 65 is initiated. In one example, the synchronization adjustment process and other receiver circuitry may be inactivated until a frame is found. Once the frame is found, then the sync process and other circuitry may be turned on. In this way power is conserved. The sync process may be, for example, a sync process like the sync process to be described with reference to FIG. 10. Once a synchronization is found, which may take the form of a synchronization adjustment as shown in block 67, the baseband process then begins sequentially decoding symbols as shown in block 69. The decode process may be like the decode process that is described with reference to FIGS. 13 and 14. The decode process continues to decode sequential symbols as shown in block 71. Accordingly, the automatic gain control, frame detect, synchronization process, and decode process may all operate using only a single bit from the digitized baseband signal. This baseband receiver structure simplifies circuitry, conserves power, and efficiently detects, synchronizes, and decodes baseband signals. The digitized baseband signal may also be used in a clear channel assessment process 78 to report 81 the availability of a communication channel.

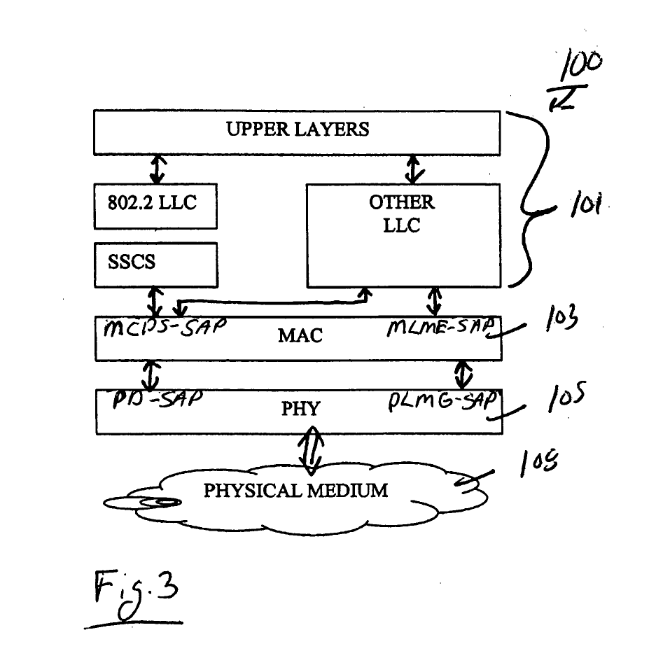

FIG. 3 shows a general device arrangement 100 for a wireless communication receiver. More particularly, the device arrangement 100 is the general device arrangement for an 802.15.4 compliant receiver. The device operates in a physical medium 108, such as the open air. Other receivers may operate with different physical mediums, such as twisted pair or cable transmission mediums. The physical medium 108 couples to the physical layer 105 of the transceiver device. The physical layer 105 of the device is responsible, among other things, for data transmission and reception. Accordingly, the baseband process described earlier operates primarily on the physical layer. The physical layer 105 may receive instructions, data, and commands from the media access layer (MAC) 103, which receives commands from upper layers 101 of the device, such as the application layers.

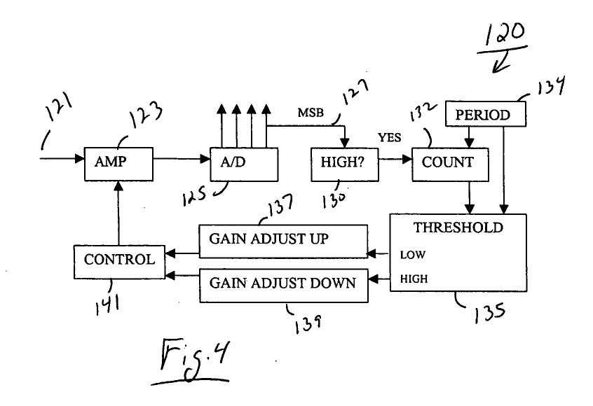

Referring now to FIG. 4 a block diagram of an automatic gain control circuit (AGC) is illustrated. It will be appreciated that the AGC may be implemented using other known alternative circuits. The automatic gain control circuit 120 receives a baseband signal 121 into an amplifier 123. The amplifier 123 applies a gain to the signal and amplifies the signal that is received into an A to D converter 125. It will be appreciated that the amplifier 123 may be, for example, an operational amplifier, or other amplifier constructed for use in portable devices. The A to D converter 125 converts the analog amplified baseband signal into a quantified digital signal. In an example of the A to D converter 125, it provides a four-bit quantification. It will be appreciated that other bit lengths may be selected for specific applications.

The most significant bit 127 is monitored to determine if it is in a high state as shown in block 130. Each indication of a high signal may be counted in the count circuitry 132. The count circuitry is reset according to a period set in period circuitry 134. It will be appreciated that the length of the period may be adjusted according to application specific needs, the speed of the A to D conversion, and the amount of time allowed for the automatic gain circuitry to settle. Each time the period circuitry resets, the count is set to zero. Upon receiving an indication that a high most significant bit has been received, the count circuitry increments. A threshold has been predefined and is stored in threshold circuitry 135. In one example, both a low threshold and a high threshold have been predefined.

Upon the completion of a period, the count of the most significant bits is compared to the predefined thresholds. If the number of counts exceeds the high threshold, that may be an indication that the A to D converter is at or approaching a saturation point. Accordingly, the gain adjust circuit 139 is used to set control circuitry 141 to lower the gain of amplifier 123. In a similar manner, if the count indication is too low, then gain adjust circuitry 137 would be activated to set the control 141 to increase the gain of the amplifier 123. Accordingly, monitoring the most significant bit off of the A to D converter allows efficient gain control of the A to D converter.

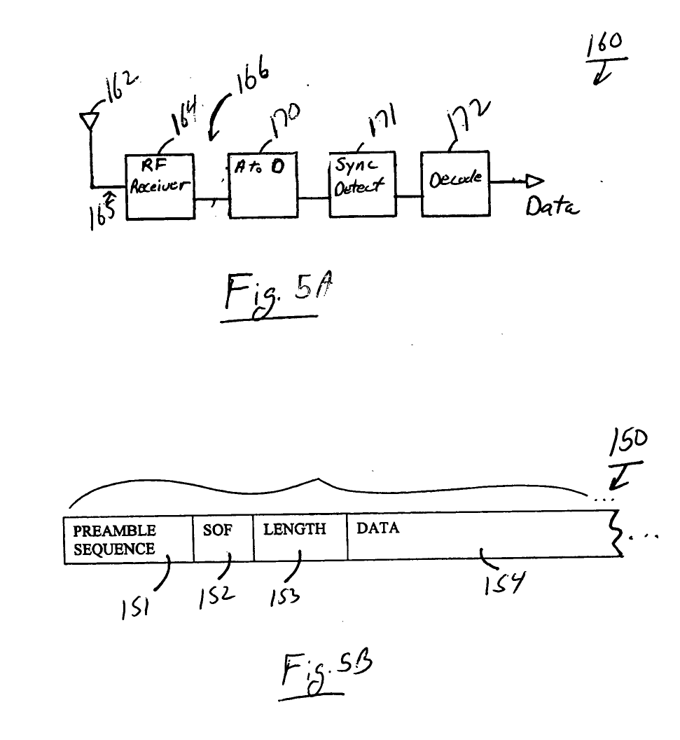

Referring now to FIG. 5A, a general receiver architecture 160 is described. The receiver 160 has an antenna 162 receiving an RF (radio frequency) signal. The RF signal 165 is received into an RF receiver 164. The RF receiver 164 may include, for example a binary phase shift key demodulator (BPSK). The operation of an BPSK demodulator is well known, and therefore will not be described herein. The BPSK demodulator outputs a baseband signal 166. The baseband signal 166 is sent to an analog to digital (A to D) converter 170. The A to D converter 170 quantitizes the baseband signal and passes the result to a sync adjustment block 171. Since initially the signal passed from the A to D converter is asynchronous, the receiver does not know the starting point for symbol detection and therefore the receiver is responsible for synchronizing to the baseband signal. Further, the network does not provide a synchronization assist, so the receiver is solely responsible for synchronizing using the incoming RF signal. Once the sync adjustment block 171 has determined any synchronization adjustment, then the decoding process may be adjusted according to the incoming baseband signal. In this way the decode block 172 may then efficiently decode individual data symbols into data information 173.

FIG. 5B shows the general format used to transmit data in a baseband signal for an 802.15.4 compliance system. It will be appreciated that modifications may be made to the data format consistent with the 802.15.4 standard, and that other formats may be used for other communication systems and standards. The data frame 150 has a preamble section 151 which is followed by a short start-up frame portion 152. Next, a frame length indicator 153 is given, with the data 154 following immediately thereafter. Importantly, the preamble sequence 151 is only 8 symbols long. It is therefore important and highly desirable that the baseband process provide for synchronization within this 8-symbol preamble period so that the receiver is prepared to receive the start frame indicator 152, frame length 153, and the data 154.

Referring now to FIG. 6, a process 175 for frame detection is illustrated. Frame detect process 175 is useful for detecting the presence of a data frame prior to activating other receiver circuitry. For example, frame detect process 175 may be able to detect a data frame prior to synchronization of other process circuitry, and without the need for decoding any individual symbols. In this way, the frame detect process may be accomplished in a short period of time using minimal circuitry and power. It will be appreciated that other conventional frame detect circuitry may be used consistent with this disclosure.

Frame detect process 175 operates by detecting the presence of a preamble that identifies a data frame. In the 802.15.4 standard, the preamble includes 8 sequential and identical symbols. For example, symbol 177 and symbol 178 are alike. It will be appreciated that other communication standards may have different sequences that indicate a data frame. In the receiver, an A to D converter digitizes the baseband signal, which may include the preamble symbols. The digitizer may digitize at a rate sufficient to facilitate efficient detection and decoding, but that does not use unduly complex circuitry. For example, an A to D converter for a 915 MHz band receiver may be set to digitize at 2.4 MHz, which generates 60 samples in each symbol period (or 4 per chip value). In another example, an A to D converter for a 868 MHz band receiver may be set to digitize at 1.2 MHz, which also generates 60 samples in each symbol period (or 4 per chip value). The 1.2 or 2.4 MHz rate also permits the use of commonly available components and relatively simple circuitry, but still enables sufficient resolution to efficiently perform detection and decoding processes. It will be appreciated that other rates and bit-depths may be selected for application specific needs.

Each of the symbol periods is therefore represented by 60 data samples 179. Of course, since the 868/915 MHz bands use a BPSK modulation, there are only two available symbols: “1” or “0”. For more efficient processing and detection, each of the sample periods is apportioned into a first portion 180 with 30 samples and a second portion with 30 samples. For convenience, each one of these 30 sample portions is identified by its sample number and the portion position. For example, portion 1-1 180 identifies the first 30 samples of the first symbol period, while the second 30 samples of the first symbol period are identified as 1-2. In a similar manner the first 30 samples of the second symbol period are identified as portion 2-1 181. If the received baseband signal contains a preamble sequence, then portions 1-1, 2-1 and 3-1 should be similar. Also, portions 1-2, 2-2 183, and 3-2 should be also be similar when a preamble sequence is present. By monitoring for a high level of correlation between selected portions, process 175 efficiently detects a symbol sequence indicative of a preamble.

It will be appreciated that it may be possible to operate the frame detect process 175 synchronously with the baseband signal. For example, such synchronous operations are possible when another process provides for synchronization between transmitter and the receiver. However, frame detect process 175 may advantageously be used without synchronization between the transmitter and the receiver. In this way, the start of the first sample period 185 may not be begin on symbol zero, and further is unlikely to begin at the start of any symbol period. The sample period 185 therefore may extend over two adjacent symbols. However, since each of the preamble symbols is alike, portions 1-1 186, 2-1 187 and 3-1 188 will still have a high level of correlation when a symbol sequence is present. In a similar manner, portions 1-2, 2-2 189, and 3-2 will also have a high level of correlation when a symbol sequence is available, irrespective of the relationship between the start of the symbol period and the start of the digitized sample.

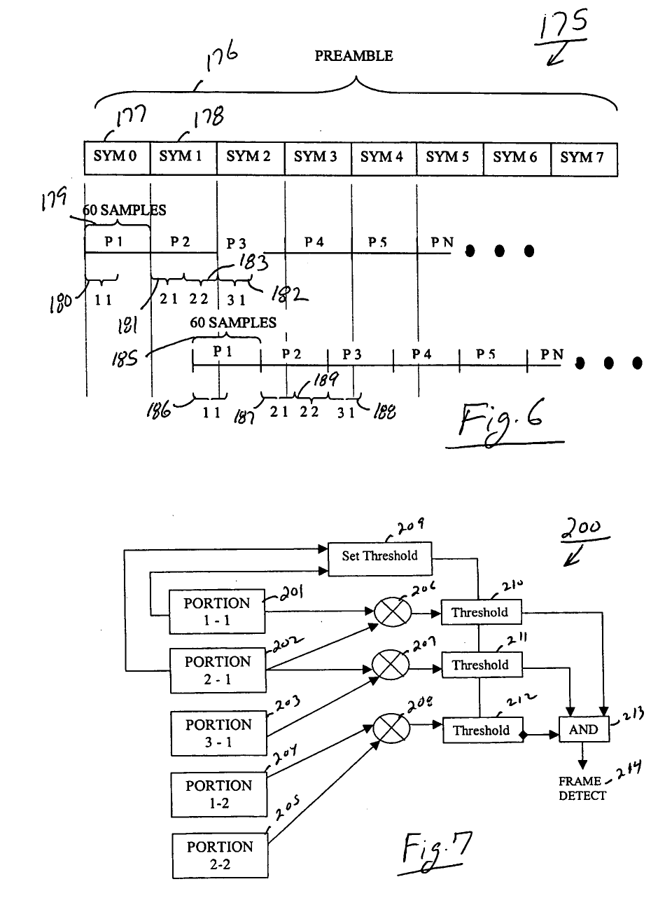

Referring now to FIG. 7, frame detect process 175 includes detection sequence 200. Detection sequence 200 uses the 30 sample digitized portions as described above. Detection sequence 200 correlates portion 1-1 201 and portion 2-1 202 in correlator 206. In a similar manner correlator 207 correlates portions 2-1 202 and 3-1 203. Finally, correlator 208 correlates portions 1-2 204 to 2-2 205. It will be appreciated that other portion correlations maybe used depended upon specific timing, power, and application needs. A threshold is set 209. The threshold may be set, for example, by using the digitized signals to estimate a signal to noise ratio. More specifically, the threshold may comprise an autocorrelation function using one or more sample portions. For example, autocorrelations may be performed on portion 1-1 and portion 2-1, with the result representing an energy level. Further, the threshold may be adjusted by applying a factor that is based upon practical experience and testing. It will be appreciated that the threshold may be defined, set, and adjusted in alternative ways consistent with this disclosure.

The output from correlator 206 is compared to the threshold 210, the output from correlator 207 is compared to threshold 207, and the output from correlator 208 is compared to threshold 212. All of the outputs from the threshold comparison are compared in block 213, and if all of the correlator signals exceeded the threshold, then process 200 indicates a positive frame detect 214. If a frame is not detected the process 200 resets and compares portions in the next sample period.

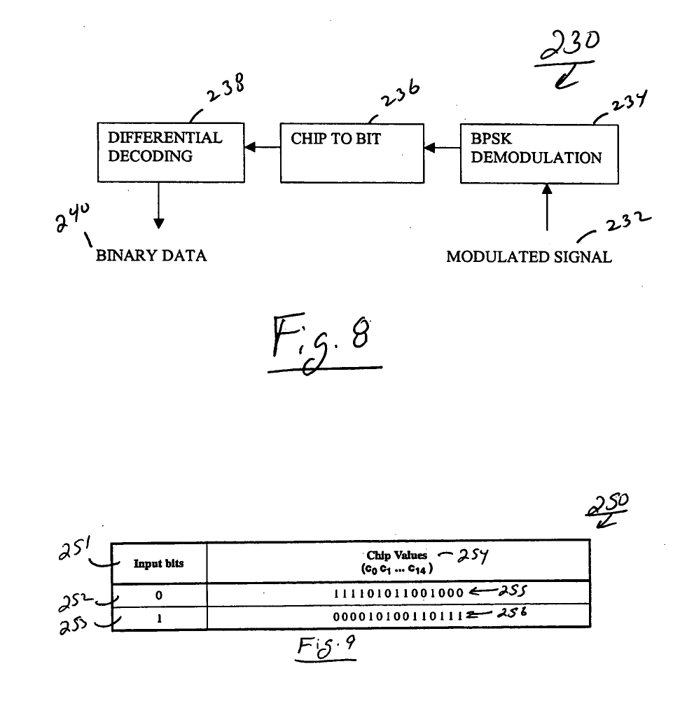

Referring now to FIG. 8 a receiver 230 is shown. The receiver 230 has a modulated RF-in signal 232. The RF-in signal is received into an BPSK demodulator 234. The BPSK demodulator 234 removes the carrier signal and generates a baseband signal indicative of the binary symbols. The baseband waveform signal is digitized and sampled, with the samples provided in sample sets related to the symbol period. The baseband waveform signal, however, is initially provided to the rest of the receiver as an asynchronous waveform, and is likely degraded due to frequency offsets, interference, noise, fading, timing delays, and other degrading influences. Further, the digitizing and sampling process may be out of phase with the baseband signal, since no sync signal is provide. In order to decode the baseband signal, a sync adjustment or offset is determined for the baseband signal. The sync adjustment is used to synchronize the decode process with the symbols carried by the baseband signal. The sync adjustment information is passed to the decode section. The decode section converts the baseband waveform from a chip representation into a symbol representation in block 236. The illustrated example uses on a “0” symbol and a “1” symbol, so the symbols are synonymous with a binary representation. The decoding process is discussed more fully in the discussion of FIG. 13, which follows below. Once the symbols have been identified in block 236, the symbols may be decoded into binary data 240 using the differential decoding block 238.

The 868/915 MHz band for the 802.15.4 standard maps binary data into chips. As shown in FIG. 9, each of the binary input bits 251 is mapped to a specific chip value 254 pattern. More specifically, each binary symbol 252 and 253 is coded into 15 sequential chips 255 and 256 respectively. For example, the binary symbol “0” will be encoded using the chip pattern of “111101011001000”, while the binary “1” symbol will be encoded using the chip pattern of “000010100110111”. Accordingly, each binary symbol is represented by 15 coded chip portions. For the 868 MHz band, which has a bit rate of 20 kBits per second, the corresponding chip rate is 300 k chips per second. In this way, each bit symbol has a period of about 50 microseconds, and each chip has a chip period of about 3.33 microseconds. For the 915 MHz band, which has a bit rate of 40 kBits per second, the corresponding chip rate is about 600 k chips per second. In this way, each bit symbol has a period of 25 microseconds, and each chip has a chip period of about 1.67 microseconds.

Referring now to FIG. 10a a receiver synchronization process 275 is shown. Receiver process 275 receives a baseband signal 277 from another portion of the receiver, such as a BPSK demodulator. The baseband signal 277 has had its carrier removed, but still may be highly degraded due to the effects of frequency offset, noise, fading, timing delays, and other degrading influences. In order to remove or minimize the effects of these degrading influences, the baseband signal 277 is correlated with a delayed version of itself, which is a form of auto-correlation. More particularly, the baseband signal 277 is received into correlator 297 and the baseband signal is also delayed by delay 290. The delay 290 generates a delayed signal 294 that is also received into the correlator 297. The baseband signal is correlated with the delayed baseband signal to produce a processed signal 302. The processed signal 302 is then received into another correlator 306.

Since the communication standard defines the allowed symbols and the encoding processes, an expected pattern 285 may be determined. For example, the preamble pattern in the 802.15.4 standard is a series of 8 “0” symbols. In another example, the chip pattern associated with each symbol is also defined in the standard. It will be appreciated that additional patterns may be defined, and other standards may allow for other patterns. The expected pattern 285 is passed through a preload process 283. The preload process shapes the pattern 285 into the form of an expected waveform. The possible expected waveforms 287 are then loaded into a reference table 281. In this way, the reference table 281 is loaded with a set of reference waveforms 287. Each of these waveforms may then be provided as a reference signal input 279. The reference signal 279 is passed through a preprocessing process similar to that performed on the baseband. The reference waveform 279 is correlated in correlator 299 with a version of the reference signal 296 that has been delayed using delay 292. Correlator 299 generates a processed reference signal 304. The processed reference signal 304 is then passed into correlator 306.

Correlator 306 then provides a result 308 that indicates the level of correlation between the processed baseband signal 302 and each processed reference signal 304. By correlating each of the reference signals in reference table 281, the reference signal having the best correlation may be found. Once the best correlating reference signal is found, an important characteristic of the baseband signal has been located. For example, the receiver process 275 may be used to locate a sync adjustment or offset for an asynchronous baseband signal, or may be used to efficiently decode a baseband signal once synchronization has been found.

FIG. 10b shows another receiver process 310. The baseband portion 311 of receiver process 310 is similar to the process described with receiver process 275, so will not be described here in detail. However, receiver process 310 has a reference table 312 that is preloaded with reference signals already in the form for finally correlation. More specifically, each of the reference signals in reference table 312 is like one of the processed reference signals 304 described with reference to FIG. 10a. By loading the reference table 312 with the processed reference waveforms, the receiver circuitry may be simplified. The processed baseband signal and each processed reference signal are correlated in correlator 313, which produces a result 315 like result 308 described with reference to FIG. 10a.

Referring now to FIG. 11, process 325 is illustrated, which is useful for generating a table of reference signals for assisting in finding a sync offset. As generally described above, the 802.15.4 standard defines a preamble consisting of 8 sequential “0” symbols. Accordingly, it is only necessary to look for the “0” symbol to locate the preamble of a data frame. Since the process will only be looking for the “0” symbol, the “0” symbol 355 may be used as the expected pattern. The “0” symbol is then converted into its chip format in block 351. A chip table 353 is provided in the 802.15.4 standard for converting the symbol zero into its associated chips (see FIG. 9). The chip waveform may then be passed through a waveform shaping circuit 346 to further shape the chip waveform into an expected baseband signal 327. The expected baseband signal 327 is then sampled by an A to D converter 341 so that each symbol period has a sample set that consists of 60 samples or data points. It will be appreciated that the expected baseband signal 327 may be mathematically modeled or may be actually generated and sampled using a receiver device.

The A to D converter 341 is operated at 4 times the frequency of the chips, which correspond to a frequency of either 2.4 or 1.2 MHz, as described earlier It will be appreciated that other sampling frequencies may be used consistent with this disclosure. Since the symbol 331 is either 25 or 50 microseconds in duration, the corresponding digitizing of a symbol period will require 60 samples. In one example of the process, the A to D converter is a 1-bit A to D, which enables a particularly efficient synchronization process.

Once the expected waveform 327 has been sampled, then the reference table 342 can be loaded. For example, waveform R0 357 would represent an expected waveform sampled from sample 0 through sample 59. The next reference signal, R1 358 represents an expected waveform starting at sample 1 and continuing through sample 59 and ending with sample 0. In a similar way, reference signal R2 359 represents an expected waveform sample starting at sample 2 and continuing through sample 59 and ending with sample 1. The pattern of loading the reference table continues through expected reference waveform R59 361 which would represent an expected waveform if sampling started at sample 59 and then continues to sample 58. When the reference table 342 is fully loaded, the reference table contains 60 reference signals, with each reference signal representing an expected waveform depending on the possible starting points for sampling a “0” symbol.

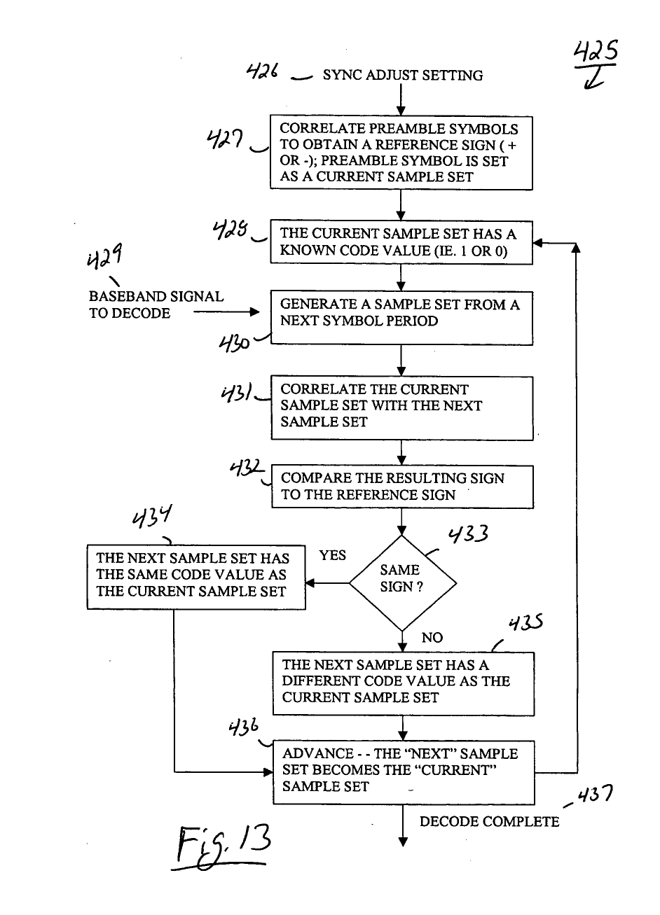

Referring now to FIG. 12 a receiver portion 380 is shown. The receiver portion 380 has a reference table 384 loaded as described in FIG. 11. Accordingly, each of the reference waveforms 386 correspond to a sample offset of the expected preamble. Each of the reference waveforms is used as an input into a preprocessing section. For example, R0 388 is delayed 399 and correlated 401 with the output passed to correlator 410. In a similar manner, R1 390 is delayed 395 and correlated 402 with the result passed to correlator 411. Also, R2 392 is delayed 396 and correlated 403 with the result passed to correlator 412. Each of the reference waveforms is used as an input until all the possible reference waveforms are provided as input. For example, R59 393, the final waveform, is delayed 397 and correlated 404, with the result passed to correlator 413. It will be understood that the process of processing the reference signals may be done sequentially, or may include a multiplexing process which enables a parallel operation.

The baseband signal 382 is received in an asynchronous manner, and is delayed 406 and correlated in 407. The correlation in 407 removes the effects of any frequency offset and other degrading influences from the baseband signal, with the resulting signal then passed into correlators 410, 411, 412, and 413, where the processed baseband signal is correlated with each of the reference signals. It will be appreciated that the correlation process may be done sequentially, or may include a multiplexing process that enables a parallel operation. An accumulator or maximizing circuit 415 detects which of the correlators provides the highest power output, which would correspond to the best correlation. Since each reference signal is associated with a different sample start time, the reference signal having the best correlation will indicate the sample offset for the A to D converter. This sample offset may be used as a sync offset for synchronizing the receiver to the start position for each symbol in the baseband signal. The power level 417 of the best correlation and the index for sync offset 419 is reported from the receiver portion 380. For example, if R2 392 provided a power P2 into maximizer 415, and P2 was determined to be the highest power level, then the power level P2 would be recorded as power level 417, and the index “2” would be reported. In this way, the receiver now knows that a sync offset of 2 should be applied during the decoding process. With the sync adjustment or offset known, a more efficient symbol decoding process is enable, such as the decode process illustrated in FIG. 13 and described more fully below. It will be appreciated that other decode processes may be used.

Referring now to FIG. 13 a method of decoding a baseband signal is shown. Decoding process 425 preferably is synchronized to the baseband signal. In particular, a sync adjustment setting 426 or synchronization offset may be received from another baseband process, such as baseband processor discussed with reference to FIGS. 10, 11, and 12. Since the decode process 425 is synchronized to the baseband signal, the process 425 is able to digitize the baseband signal into sample sets with each sample set indicative of a single code symbol.

The decode process 425 digitizes the baseband signal to obtain two sample sets in block 427, with each sample set representing a symbol in the preamble portion of a communication frame. Since each symbol in the preamble is known, for example, in the 802.15.4 standard to be a “0”, both sample sets represents a known code symbol. The two known preamble sample sets are correlated and a reference value obtained. In a particularly efficient implementation of method 425, the reference value is a reference sign representing the sign (positive or negative) of the correlation result. It will be appreciated, however, that other reference values may be used. The reference value, or reference sign, is useful to compensate for disturbances or distortions in the communication system. For example, a multipath situation may cause disturbances and distortions in the baseband signal for a period of time. By correlating two known preamble symbols, the resulting reference value or sign may be used to compensate and reduce the effects of such distortions and disturbances. This process is particularly effective for communication standards where disturbances and distortions are likely to change at a relatively slow rate. For example, since a communication standard compliant with the 802.15.4 standard is a personal area network, it would be unusual for either the receiver or transmitter to be moving at a rapid pace. Therefore, it is likely that distortions such as a multipath distortion would have a relatively slow rate of change. Also, the method 425 may be arranged so that the reference value or sign is determined independently for each new data frame. In this way, the decoding process 425 adapts to changing communication environment. It will also be appreciated that more sophisticated algorithms may be used to compensate for distortions and disturbances in the communication environment. For example, the historical record of reference values may be used to determine a future reference value or sign.

Since the sample set from the preamble has a known value of “0” as shown in block 428, the preamble sample set may be used as a decoding reference. For example, the baseband signal 429 may be digitized to generate another sample set 430 from a next sample period. In one example, the sample set may be from the data portion of the data frame. For ease of reference, the sample set corresponding to the known code symbol will be referred to as the “current” sample set, while the sample set corresponding to an unknown code symbol will be referred to as the “next” sample set. Block 431 shows that the current sample set is correlated with the next sample set. The correlation generates a correlation value, which may be in the form of a correlation sign. In this way, the correlation results are expressed using only the sign information from the correlation result. It will be appreciated that other correlation value representations may be used.

The correlation value is then compared to the reference value in block 432. In one example, the correlation sign is compared to the reference sign. If the correlation and the reference sign are the same, then the decode process determines that the next sample set has the same code symbol value as the current sample set as shown in block 434. If the correlation sign is different from the reference sign 433, then the method 425 determines that the next sample set has a different code symbol value as compared to the current sample set as shown in block 435. In this case, since the baseband signal carries binary signal information, the “different code symbol” is simply the binary complement.

The decode process 425 thereby has decoded the code value of the symbol associated with the “next” sample set. The process now advances to another sample set by defining the “next” sample set as a “current” sample set as shown in block 436. In this way, the method 425 proceeds by sequentially decoding symbols by comparing an unknown sample set to the immediately preceding known symbol. It will be appreciated, however, that the method 425 could also define a sample set, such as a preamble sample set, as a reference and make multiple correlations to that defined reference. However, the sequential process described above has proven to be particularly efficient to implement.

Referring now to FIG. 14, another decode process 450 is shown. Decode process 450 includes several sequential code symbols, each in a symbol period. For example, symbol period “A” 452 is adjacent to symbol period “B” 453 which is adjacent to symbol period “C” 454. Each symbol period has been digitized into a corresponding sample set, for example, of 60 data points. In one example of method 450, the sample set A is from an 802.15.4 preamble, and therefore has a known code symbol of “0”. Also, as more fully described above, method 450 has predefined a reference sign that compensates for communication disturbances and disruptions or other communication environmental issues.

The code symbol for symbol period A is known, while the code symbol for symbol period B is unknown. Therefore the sample set corresponding to A is correlated with the sample set corresponding to B. More particularly, the correlation of the A sample set to the B sample set generates a correlation result, preferably in the form of a correlation sign. If the correlation sign is the same as the reference sign, then the symbol corresponding to B has the same symbol of A. For example, if 1) the reference sign is positive, 2) the A symbol period is known to be “0”, and 3) the correlation sign between A and B is a positive sign, then method 450 would decode the B symbol as representing a “0” code symbol. With the B symbol period now decoded as a “0”, the process continues by correlating the sample set of B to the sample set of C. Continuing the example, if the correlation between B and C results in a negative sign correlation result, then C would be decoded as a “1” code symbol. Continuing the example, if C and D are then correlated to obtain a positive correlation sign, then D would be decoded to have the same code symbol as C, which is a “1”. The decoding process continues sequentially through the data frame. After the last symbol of the data frame has been decoded, the baseband would reset the decoding process 450 to determine a new reference value or sign for the next data frame. In this way, method 450 adapts to changing communication conditions and environments.

In another example, if 1) the reference sign is determined to be negative, 2) the A symbol period is known to be “0”, and 3) the correlation sign between A and B is a positive sign, then method 450 would decode the B symbol as representing a “1” code symbol. With the B symbol period now decoded as a “1”, the process continues by correlating the sample set of B to the sample set of C. Continuing the example, if the correlation between B and C results in a negative sign correlation result, then C would be decoded as a “1” code symbol. Continuing the example, if C and D are then correlated to obtain a positive correlation sign, then D would be decoded to have a different code symbol as C, so “D” is decoded as “1”. The decoding process continues sequentially through the data frame. After the last symbol of the data frame has been decoded, the baseband would reset the decoding process 450 to determine a new reference value or sign for the next data frame. In this way, method 450 adapts to changing communication conditions and environments.

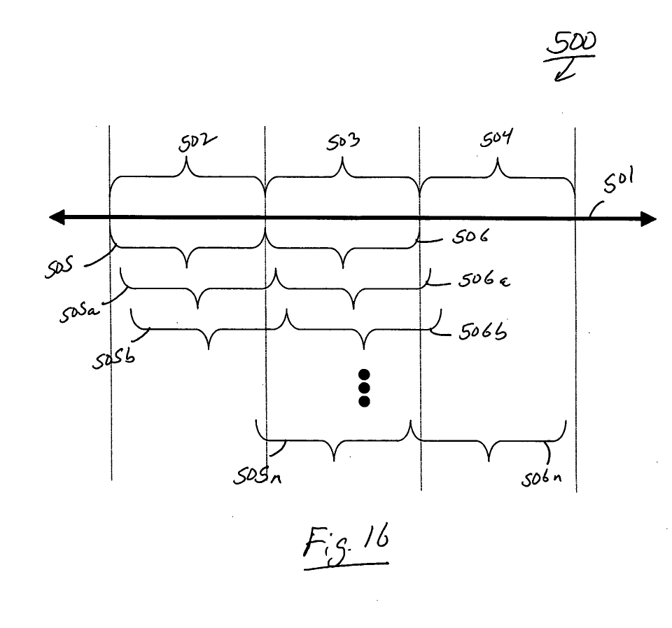

FIG. 15 shows a baseband process 475 for clear channel assessment (CCA). Clear channel assessment is a process of determining whether or not a particular channel is available to the receiver for communication. Communication standards, such as 802.15.4 prescribe particular requirements for determining that a channel is either busy or not busy. For example, a standard may define that the receiver should report a busy channel upon detecting a threshold level of energy in the appropriate channel. In another example, the CCA standard may define that the receiver shall report a busy channel only when detecting signals that appear to be communication signals operating in the same communication standard. In another alternative, the CCA standard may define that the receiver should report a busy channel upon detecting a communication signal similar to the communication signal of the communication standard, or if a threshold level of energy is present in channel irrespective of the communication standard of the signal.

Of the three alternatives, it has proven particularly difficult to identify when a channel contains a signal which is a communication signal operating in the same or similar communication standard. For example, it has been particularly troublesome for an 802.15.4 receiver to identify when a particular channel is already being used by another 802.15.4 device. More particularly, it has proven difficult to determine the start time for implementing the clear channel assessment and to synchronize the CCA process with the channel signal. Compounding the problem, it is difficult to identify a preamble section in the channel, thereby making synchronization and decoding difficult, if not impractical.

Method 475 is able to do a clear channel assessment to identify an 802.15.4 signal in a channel without the need to synchronize or decode the channel signal. In operation, method 475 receives a search instruction 476 from, for example, the MAC layer or the TX/RX module. The search instruction may request a clear channel assessment for a particular channel, or may generally ask the receiver to find an open channel. Upon receiving the search instruction, the method 475 tunes to the particular channel of interest and begins digitizing any signal present on the channel. An analog to digital converter is configured according to a defined symbol period 477 and a defined sample rate 478. For example, to search for an 802.15.4 signal operating at the 868 MHz band, the symbol period may be set at 50 microseconds and the sample rate set to about 1.2 MHz for the A to D converter. In this way, the digitizer takes sufficient samples to accurately assess the channel signal, but yet may be implemented in relatively low cost and compact circuitry. In another example, if the search is for an 802.15.4 signal operating at the 915 MHz band, then the symbol period may be defined at 25 microseconds, and the sample rate may be set at about 2.4 MHz. It will be appreciated that other symbol periods and sample rates could be used depending upon particular communication signal being searched for. In another example, the symbol period and sample rate may be adjusted to search for an 802.15.4 signal operating in the 2.4 MHz band. It will be appreciated that other sample periods and sample rates may be used depending upon specific application needs. In a particular implementation of the analog to digital converter, the analog to digital converter may be operated at a sample rate of 2.4 MHz to support searching for a signal operating in the 915 MHz band. Since the digitizer is operating at 2.4 MHz, the digitized samples also may be used to search for a signal in the 868 MHz band. It will be appreciated that every other sample point may be used in the search, or all points used.

As the channel is digitized, a first sample set is generated as shown in block 480. The first sample set holds the digitized samples from the first symbol period. For example, the first sample set may include 60 sample points that correspond to one symbol period. After the first sample set has been generated, a second sample set is generated in block 481. The second sample set also includes sample points from a second symbol period. It is important to note that the digitizer is operating on a clock independent from any communication signal on the channel under investigation. Therefore, even though sample sets are taken that relate to a symbol period, it is unlikely that the sample sets will directly correspond and synchronize with any symbol communicated in the channel signal.

Block 482 shows that the first sample set and the second sample set are correlated. The correlation results are accumulated in block 483 for future analysis. Since method 475 is operating asynchronously with any communication signal on the channel, multiple comparisons and correlations may be necessary to assess the presence of an 802.15.4 communication signal in the channel. Accordingly, the method advances 484 to perform another correlation. More specifically, the method 375 advances by one or more samples. In a particular example of method 475, the method advances one sample each time another correlation is performed. For each advance, the first sample set is adjusted to advance to include a next data point. In a similar manner, the second sample set advances to include another digitized sample point, and the first and second sample sets are again correlated and results accumulated. After advancing through a full symbol period 492, if an 802.15.4 signal is present, it is likely that the correlations between the first and second sample sets will have several high correlations. The presence of several high correlations would indicate that an 802.15.4 signal is present, while only a few or no high correlations would indicate that such an 802.15.4 signal is not present. Also, it is likely that the correlations, if an 802.15.4 signal is present, will generally indicate a Gaussian or bell-shaped distribution. Accordingly, the pattern of correlation results may also be used to define a threshold that is useful to identify the presence of an 802.15.4 signal. It will be appreciated that the number of symbols digitized, the magnitude of the correlation required, and the number of high correlations required can be adjusted according to application specific needs.

After the correlation results are compared to the predefined threshold, the clear channel assessment is reported as shown in block 489. More particularly, if the threshold is exceeded, then it is reported that the channel is busy 491 while if the threshold level is not exceeded, then the channel is reported as being not busy 490. It will also be appreciated that a magnitude of the correlation may also be reported, which may be useful for understanding the energy level of the 802.15.4 signal present in the channel.

Referring now to FIG. 16 a method for clear channel assessment 500 is shown. Method 500 includes a signal transmitted in a channel of interest 501. The signal 501 may be noise, a communication signal on another standard, or a communication standard on an 802.15.4 system. In one example, method 500 is used to determine if signal 501 includes an 802.15.4 communication signal. As described with reference to FIG. 15, the channel signal 501 is digitized and sample sets generated. A first sample set 505 includes samples from a first symbol period 502, and sample set two 506 includes sample points from a second symbol period 503. As previously described, sample sets 505 and 506 are correlated and the results saved and accumulated for further processing. The method 500 advances by, for example, a single sample period and new sample sets 505a and 506a are defined. Sample sets 505a and 506a are correlated and correlation results again saved and accumulated. Similarly method 500 advances one more sample set and defines two new sample sets 505b and 506b. Sample sets 505b and 506b are correlated with the results being saved and accumulated. This process continues through at least one symbol period, which may include about 59 correlations. To increase the accuracy of the assessment, additional symbol periods may be used. In this way, the advancement may continue through several symbol periods, with hundreds of sample sets generated and correlations being performed. By increasing the number of correlations and symbol periods, the accuracy of the clear channel assessment may be increased and thereby fewer false “busy” or false “not busy” reports may be made.

In one example of the clear channel assessment method, the clear channel assessment process acts responsive to an instruction from the MAC layer of the transceiver. Since a response to a clear channel assessment may not be particularly time critical, the clear channel assessment process may operate as a background task. In one example of the CCA process, the CCA process receives a signal from the channel of interest, and digitizes three symbols worth of data. In this way, the correlation, accumulation, and comparison processes described with reference to FIG. 15 and 16 do not have to be performed immediately or in near real time. Instead, the process may operate as a background task. In this way, the overall processing power required in the transceiver device may be minimized, thereby facilitating lower costs, lower power usage, and simpler construction.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A baseband decoding process, comprising:
providing a baseband signal including binary symbol information;
digitizing the baseband signal into sample sets;
generating a reference value by correlating a first sample set to a second sample set;
assigning a symbol code value to the second sample set;
correlating the second sample set to a third sample set to generate a correlation value;
comparing the reference value to the correlation value; and
decoding the symbol code value of the third sample set responsive to the comparison.

2. The baseband decoding process according to claim 1, wherein the first sample set and the second sample set are from a preamble portion of the baseband signal.

3. The baseband decoding process according to claim 1, wherein the second sample set is from the a preamble portion of the baseband signal and is assigned a symbol code indicative of the preamble symbols.

4. The baseband decoding process according to claim 1, wherein the reference value is either a positive sign or a negative sign.

5. The baseband decoding process according to claim 1, wherein the correlation value is either a positive sign or a negative sign.

6. The baseband decoding process according to claim 1, wherein the comparing step includes comparing the sign of the reference value to the sign of the correlation value.

7. The baseband decoding process according to claim 6, wherein if the sign of the reference value is the same as the sign of the correlation value, then the symbol code value of the third sample set is decoded to have the same symbol code vale as the second sample set.

8. The baseband decoding process according to claim 6, wherein if the sign of the reference value is not the same as the sign of the correlation value, then the symbol code value of the third sample set is decoded to have a different symbol code vale as the second sample set.

9. A baseband decoding process, comprising:
providing a baseband signal including binary symbol information, the baseband signal having a preamble portion and a data portion;
generating a first sample set indicative of a first preamble symbol and generating a second sample set indicative of a second preamble symbol;
generating a reference sign by correlating the first sample set to the second sample set;
generating a first data sample set indicative of a first data symbol from the data portion of the baseband signal;
correlating one of the preamble sample sets to the first data set to generate a correlation sign; and
decoding the symbol code value of the data sample set to be the same as the code value of the preamble sample set if the reference sign and the correlation sign are the same.

10. The baseband decoding process according to claim 9, where the baseband signal is provided as a baseband signal compliant with the 868/915 MHz bands of the IEEE 802.15.4 standard.

11. The baseband decoding process according to claim 9 wherein the sample sets use only the most significant bit of an analog to digital converter.

12. The baseband decoding process according to claim 9 wherein the sample sets use fewer than the full bit resolution of an analog to digital converter.

13. A baseband decoding process, comprising:
providing a baseband signal including binary symbol information, the baseband signal having a preamble portion and a data portion;
digitizing the baseband signal into sequential sample sets;
generating a reference value by correlating sample sets having the same symbol code value;
assigning a symbol code value to a current sample set;
correlating the current sample set to a next sample set to generate a correlation value; and
decoding the symbol code value of the next sample set to be the same as the code value of the current sample set if the reference value and the correlation value are the same.

14. The decoding process according to claim 13, wherein the reference value is a reference sign and the correlation value is a correlation sign.

15. The decoding process according to claim 13, further including advancing the next sample set to be the current sample set and using another one of the sequential sample sets as the next sample set.

16. The baseband decoding process according to claim 13, wherein the baseband signal is provided as a baseband signal compliant with the 868/915 MHz bands of the IEEE 802.15.4 standard.

17. A baseband clear channel assessment (CCA) process to determine if a channel is busy or not busy, comprising:
defining a symbol period related to the symbol period of a communication standard;
generating a first sample set by digitizing a channel signal in a first symbol period, the first sample set starting with a first starting sample;
generating a second sample set by digitizing the channel signal in a second symbol period, the second sample set starting with a second starting sample;
correlating the first sample set and the second sample set to determine a correlation result;
advancing, responsive to completing the correlation, the first starting sample and the second starting sample so that a new first sample and a new second sample are generated, and correlating the new first sample set to the new second sample set to determine another correlation result;
comparing the correlation results to a threshold; and
reporting the channel is busy if the threshold is exceeded.

18. The baseband clear channel assessment (CCA) process according to claim 17 wherein the first symbol period and the second symbol period set are adjacent.

19. The baseband clear channel assessment (CCA) process according to claim 17 further including repeating the advancing step for each sample in the first sample set.

20. The baseband clear channel assessment (CCA) process according to claim 17 further including repeating the advancing step for each samples in more than one sample period.

21. The baseband clear channel assessment (CCA) process according to claim 17 wherein the advancing step includes advancing by a single sample period.

22. The baseband clear channel assessment (CCA) process according to claim 17 wherein the symbol period is set to 25 microseconds, and the comparing step includes comparing the correlation results to detect a communication signal in the 915 MHz band of 802.15.4.

23. The baseband clear channel assessment (CCA) process according to claim 22 wherein the comparing step includes comparing the correlation results to detect a communication signal in the 868 MHz band of 802.15.4.

24. The baseband clear channel assessment (CCA) process according to claim 17 wherein the symbol period is set to 50 microseconds, and the comparing step includes comparing the correlation results to detect a communication signal in the 868 MHz band of 802.15.4.
